(19) United States
(12) Patent Application Publication
(10) Pub. No.: US 2020/0385929 A1
(43) Pub. Date: Dec. 10, 2020

(54) RECYCLABLE AND REPULPABLE TRANSLUCENT OR TRANSPARENT PAPER - USE FOR PACKAGING APPLICATIONS

(71) Applicant: AW BRANDING LIMITED, ABERDEEN (GB)

(72) Inventors: Jean-Marie BAUMLIN, ANZIN SAINT-AUBIN (FR); Gaël DEPRES, CHIRENS (FR); Jean-Marie VAU, PARIS (FR); Glyn HARBURN-JONES, Kent (GB)

(21) Appl. No.: 16/764,077

(22) PCT Filed: Nov. 14, 2018
(86) PCT No.: PCT/EP2018/081236

§ 371 Date: May 14, 2020

(30) Foreign Application Priority Data
Nov. 14, 2017 (EP) 17306582.2

(51) Int. Cl. D21H 19/82; D21H 19/24; D21H 19/20; D21H 19/84; D21H 27/00; B41M 5/50; B41M 5/00

(52) U.S. Cl. CPC D21H 19/824; D21H 19/24; D21H 19/20; B41M 5/0047; D21H 27/00; B41M 5/502; D21H 19/84

(57) ABSTRACT

Disclosed is translucent or transparent paper suitable for laminate and packaging applications, and more particularly a translucent paper having improved transparency by a coating process. The transparent or translucent paper serves as a recyclable, repulpable and renewable alternative to plastic wrappers and laminates.

### BACKGROUND OF THE INVENTION

### Field of the Invention

The present invention relates to translucent or transparent paper suitable for laminate and packaging applications. More particularly, the present invention relates to a translucent paper having improved transparency by a coating process. Said transparent or translucent paper serves as a recyclable, repulpable and renewable alternative to plastic wrappers and laminates.

The invention also relates to a process for the manufacture of a transparent or translucent paper and to the use of the obtained paper in various domains including packaging of any type of goods such as consumer goods or food products.

The translucent or transparent paper of the invention comprises a fibrous substrate, in particular a paper sheet having an opacity less than or equal to 45%, preferably a natural tracing paper (i.e. tracing paper made of highly refined cellulose fibers), and a coating layer disposed (coated) on said fibrous substrate. Said coating layer enhances transparency of the fibrous substrate while also providing good barrier properties against moisture.

In one aspect, one or more coating layers are disposed on both the front side and the reverse side of the fibrous substrate. The coating layer(s) disposed on the front side and the reverse side of the fibrous substrate may or may not be of the same nature. The resulting translucent or transparent paper may be used as a wrapper for an item such as consumer goods or food products.

In another aspect, the reverse side of the fibrous substrate comprises a printed feature.

The printed feature is laterally inverted when viewed from the reverse side of the fibrous substrate and readable left-to-right when viewed from the front side of the fibrous substrate, through the coating layer(s) and the fibrous substrate. One or more layers of white ink may be disposed over the printed feature on the reverse side of the fibrous substrate in order to enhance contrast of the printed feature.

The present invention further discloses a product comprising said translucent or transparent paper, wherein said translucent or transparent paper is bonded, through a layer of glue or adhesive, to a paper or paperboard/cardboard support, for example in form of an item of any shape and size and accordingly, said translucent or transparent paper covers said support at least in part, for example its external surface or its internal surface, and possibly its entire surface.

The present invention also relates to a method of producing said translucent or transparent paper and a method of producing said product comprising said translucent or transparent paper.

Also disclosed is the use of said translucent or transparent paper for packaging, especially luxury packaging, in order to wrap, hold or laminate objects. Such packaging encompasses closed boxes or containers that protect, identify and transport a wide range of goods, including food and consumer products. The transparent or translucent paper of the invention may accordingly be provided in any format suitable for packaging such as sheets, or wrappers, which are flat, rolled, or folded. The paper of the invention accordingly acts as a protection of the element (whether liquid or solid) that it contacts, surrounds or contains, or as a cover which allows said element to be seen through the paper due to its transparency. In particular, the paper of the invention may serve the purpose of protecting the item it contacts, surrounds, contains or covers against scratches, fingerprints, oil/water stains, oxygen and other contaminants. In contrast to most packaging materials known in the art, the paper of the invention is not made of nor does it contain plastic film and may additionally have a soft surface that prevents abrasions and allows for color and touch effects.

### Description of the Related Art

Packaging materials such as wrappers are used to protect items against external aggressions and contaminants such as scratches, fingerprints, as well as oil and water stains. Petroleum-based plastics, in particular plastic films, are the most popular packaging material due to their low weight, flexibility, durability, transparency, versatility, as well as chemical stability.

Paper-plastic film laminates are also often used for packaging articles such as boxes and bags, especially for luxury goods.

Unfortunately, most plastics are currently made from non-renewable carbon sources and pose environmental concerns. In addition, they are not easily recycled. Thus, plastics do not provide a solution for companies looking for recyclability, environmental sustainability, and repulpability of packaging materials.

To this end, the two important actions necessary in the packaging industry are: first, using renewable raw materials, and second, facilitating recovery and recycling of used packaging materials.

The environmental concerns prompted the development and use of plastic films that are not derived from petroleum, such as PE films made from bioethanol. Although such plastic materials are renewable, it is difficult to recycle once they are laminated to paperboards.

There also exist plastics synthesized via green chemistry route. For example, plant-based polylactic acid (PLA) derived from corn starch, such as one developed by Toray, is gaining its popularity as an alternative to petroleum-derived plastics. This material is renewable and recyclable, but once it is laminated to a paperboard it is difficult to recycle.

European patent EP3087129 describes biodegradable plastics which are degradable into low molecular weight oligomers or monomers by the use of enzymes. Such plastics are recyclable but not necessarily renewable, and once laminated to a paperboard it is difficult to recycle.

U.S. Pat. No. 4,569,888 teaches transparentized paper by means of impregnating polymers within the fibrous network and crosslinking in-situ. The process leads to highly transparentized paper which is recyclable and repulpable. However, the oil and gas barrier properties of the paper as well as the possibility of further enhancing transparency of such paper after the paper manufacturing process by simple means are not envisaged.

### SUMMARY OF THE INVENTION

The inventors have advantageously designed a paper-based packaging material as an alternative to plastics used as wrappers or lamination films. Said paper-based packaging material is made from a renewable resource and is recyclable.

The paper of the invention accordingly solves the problem faced by the prior art that is to devise a recyclable and repulpable solution to replace packaging materials made of plastics, in particular plastic films. Further, the paper of the invention surprisingly affords delivering a transparent or translucent paper that has improved transparency compared to the known translucent paper, especially tracing paper, which also exhibits dimensional stability and barrier properties against external aggressions. In addition, such paper shows extra printability capabilities as it allows printing on the back face (or reverse side) of the paper alternatively or in addition to printing on the front face (or front side) when used. It may further have a tactile effect such as a soft-touch effect.

The physical structure of a paper allows for about 40% light scattering from the top surface of the paper, about 20% light scattering from the bulk of the paper, and about 40% light scattering from the bottom surface of the paper, which add up to give 100% opacity. Thus, by reducing the amount of light scattering, transparency is gained.

The invention discloses a paper sheet that is rendered more translucent or transparent than commonly known tracing papers. Up to 20% of transparency may be gained (or up to 20% of the light scattering ability is reduced) during the paper manufacturing process, for example by reducing the air/cellulose fiber interfaces or porosity within the bulk of the paper. Up to 40% of transparency is gained by applying a coating on the top surface of the paper, and similarly, up to 40% of transparency is gained by applying a coating (of the same or different nature from that of the top surface) on the bottom surface of the paper. The coating applied on the top or the bottom surface of the paper reduces the light scattering ability by reducing the surface irregularities and/or by reducing surface inhomogeneity present due to a refractive index mismatch between air bubbles and cellulose fibers. The present invention concerns transparentization by coating on the surface of a fibrous substrate, in particular translucent paper sheet, unlike transparentization that would take place by impregnation of said fibrous substrate. The coating layer accordingly does not substantially penetrate into the fibrous substrate, especially no deeper than filling in the surface irregularities/roughness of said fibrous substrate. Thus, the coating layer does not impregnate the fibrous substrate. In other words, the techniques applied to deposit the layer are conventional techniques leading to a short time scale of contact between the fibrous substrate and the coating composition before it starts to dry. This time scale is typically less than 10 seconds, or even less than 5 seconds.

Advantageously, the fibrous substrate of the translucent or transparent paper does not contain oils or resins to be rendered translucent. In a particular embodiment, the translucent or transparent paper does not contain oil and/or resin in the fibrous substrate. Specifically, the fibrous substrate is not transparentized by impregnation with oil and/or resin, or by addition of oil and/or resin in the pulp at the time the fibrous substrate is formed. Thus, the fibrous substrate is not an oil- or resin-impregnated paper substrate such as vellum.

The inventors have surprisingly observed that coating layer(s) may be defined and provided to enhance the transparency of a translucent paper used as a substrate, in particular a natural tracing paper, while creating moisture barrier property at the same time. In addition, the inventors have found that the addition of the moisture barrier property in the coating layer greatly reduced the hygro expansion coefficient of the translucent paper and consequently obtained an unexpected level of improvements in dimensional stability of said translucent or transparent paper, especially made from a natural tracing paper with highly refined cellulose fibers. Furthermore, the transparentization of the translucent paper by applying coating layer(s) enabled a feature to be printed on the reverse side of the translucent or transparent paper in a reverse mode so that the printed feature can be read from the front side of said translucent or transparent paper while being protected from moisture, oxygen, grease and other environmental factors.

The present invention relates in particular to the following embodiments:
1. A translucent or transparent paper comprising:
   (i) a fibrous substrate having a front side and a reverse side, an opacity index of said fibrous substrate being less than or equal to 45% measured in accordance with the ISO 2471 standard; and
   (ii) a coating layer disposed on the front side of said fibrous substrate, a composition of said coating layer comprising a material chosen from the group comprising or consisting of copolymers or homopolymer of vinylidene chloride, copolymers or homopolymer of styrene such as styrene 1,3-butadiene, copolymers or homopolymer of acrylic, copolymers or homopolymer of polyester, paraffin such as paraffin wax, and mixtures thereof,
      wherein the coating layer has a dry coat weight in a range from 1 to 40 g/m², preferably from 2 to 20 g/m², even more preferably from 4 to 12 g/m².
2. The translucent or translucent paper wherein the coating layer is also disposed on the reverse side of the fibrous substrate.
3. According to embodiments 1 or 2, the materials (also designated as components or chemicals) comprised in the coating layer are suitable to confer moisture barrier properties, have transparentization capability when the coating layer is applied on said fibrous substrate, and enable the translucent or transparent paper to be repulpable.The translucent or transparent paper of embodiment 1 having at least one of the following properties or any combination of 2 or 3 of these properties:
   (i) an opacity index less than or equal to 25% measured in accordance with the ISO 2471 standard;
   (ii) a water vapour transmission rate less than or equal to 20 g/m²/day at 85% Relative Humidity (RH) and 23 ° C.; or
   (iii) a hygroexpansivity less than or equal to 1%, preferably less than or equal to 0.5%, and even more preferably less or equal to 0.25%, when changing Relative Humidity (RH) from 15% to 80% then to 15% in 8 hours.
4. The translucent or transparent paper of any of embodiments 1 to 3, wherein the fibrous substrate has a basis weight in a range from 40 to 200 g/m².
5. The translucent or transparent paper of any of embodiments 1 to 4, wherein the fibrous substrate comprises cellulose fibers refined to above 40° SR, in particular above 60 ° SR, preferably above 80 ° SR (Schopper-Riegler).
6. The translucent or transparent paper of any of embodiments 1 to 5, wherein the fibrous substrate is selected from a group consisting of tracing paper, glassine paper, impregnated paper, and parchment paper.
7. The translucent or transparent paper of any of embodiments 1 to 6, wherein the fibrous substrate is a tracing paper, in particular natural tracing paper with highly refined cellulose fibers as disclosed above.
8. The translucent or transparent paper of any of embodiments 1 to 7, wherein the coating layer has a dry coat weight in a range from 1 to 20 g/m², preferably from 2 to 10 g/m², even more preferably from 3 to 8 g/m².
9. The translucent or transparent paper of any of embodiments 1 to 8, wherein two or more coating layers are disposed on at least a portion of the front side of the fibrous substrate.
10. The translucent or transparent paper of any of embodiments 1 to 9, wherein two or more coating layers are disposed on at least a portion of the reverse side of the fibrous substrate.
11. The translucent or transparent paper of any of embodiments 1 to 10, wherein a primer layer is disposed between the front side of the fibrous substrate and the coating layer.
12. The translucent or transparent paper of any of embodiments 2 to 11, wherein the primer layer is disposed between the reverse side of the fibrous substrate and the coating layer.
13. The translucent or transparent paper of embodiment 11 or 12, wherein the primer layer has a thickness in a range from 0.1 to 4 μm.
14. The translucent or transparent paper of any of embodiments 11 to 13, wherein the primer layer comprises a resin soluble in an organic solvent, such as alcohol.
15. The translucent or transparent paper of embodiment 14, wherein the organic solvent is selected from a group consisting of methanol, ethanol, acetone, iso-propanol, ethyl acetate, and methyl ethyl ketone.
16. The translucent or transparent paper of embodiment 14 or 15, wherein the resin is selected from a group consisting of polyurethane resin, polyamide resin, acrylic resin, alkyd resin, polyester resin, phenolic resin, derivatives of said resins, and any mixtures thereof.
17. The translucent or transparent paper of any of embodiments 1 to 16, wherein the coating layer comprises a copolymer or homopolymer of vinylidene chloride.
18. The translucent or transparent paper of embodiment 17, wherein the copolymer of vinylidene chloride is poly(vinylidene chloride-vinyl acrylate), poly(vinylidene chloride-acrylonitrile), or poly(vinylidene chloride-alkyl acrylate).
19. The translucent or transparent paper of embodiment 17 or 18, wherein the coating layer comprises a dried latex film of a copolymer or homopolymer of vinylidene chloride.
20. The translucent or transparent paper of any of embodiments 17 to 19, wherein the coating layer is a dried latex film of polyvinylidene chloride homopolymer, for example, Diofan A297 from Solvay.
21. The translucent or transparent paper of any of embodiments 1 to 20, wherein the amount (by mass) of the non-renewable materials comprised in the coating layer relative to the cellulose fibers contained in the fibrous substrate is in a range from 2 to 20%.
22. The translucent or transparent paper of any of embodiments 1 to 21, wherein the coating layer comprises optically transparent and electrically conductive material.
23. The translucent or transparent paper of embodiment 22, wherein the optically transparent and electrically conductive material comprises or consists of indium tin oxide (ITO), silver nanowires, graphene, and/or a conducting polymer such as polyaniline (PAN I), PEDOT, and PEDOT:PSS.
24. The translucent or transparent paper of any of embodiments 1 to 23, wherein the coating layer comprises dyes which add color to said coating layer in a way to adjust the shade of said translucent or transparent paper.
25. The translucent or transparent paper of any of embodiments 1 to 24, wherein an ink adhesion layer is disposed on the reverse side of the fibrous substrate or on the exposed face of the coating layer disposed on the reverse side of the fibrous substrate.
26.The translucent or transparent paper of embodiment 25, wherein the ink adhesion layer comprises styrene acrylate, styrene butadiene, polyvinyl Acetate, polyethylene acrylic acid, and/or modified starch.
27. The translucent or transparent paper of embodiment 25 or 26, wherein the ink adhesion layer has a thickness in a range from 0.1 to 4 μm.
28. The translucent or transparent paper of any of embodiments 1 to 27, wherein at least a portion of the exposed face of the ink adhesion layer or the exposed face of the coating layer disposed on the reverse side of the fibrous substrate comprises a printed feature.
29. The translucent or transparent paper of embodiment 28, wherein the printed feature is laterally inverted so that the feature is readable from the exposed face of the coating layer disposed on the front side of the fibrous substrate.
30. The translucent or transparent paper of embodiment 28 or 29, wherein a white ink layer is disposed on the printed feature.
31. The translucent or transparent paper of embodiment 30, wherein two or more layers of white ink are disposed on the printed feature.
32. The translucent or transparent paper of embodiment 30 or 31, wherein the white ink layer(s) is/are disposed on the entirety of the printed feature or the entirety of the reverse side of the fibrous substrate comprising said printed feature.
33. The translucent or transparent paper of any of embodiments 1 to 32, wherein the translucent or transparent paper has a basis weight of a basis weight of 42, 52, 62, 63.5, 82, 102, 112, 140, or 180 g/m², including all ranges and subranges therein, preferably in a range of 40 to 140 g/m², more preferably 40 to 100 g/m², even more preferably 40 to 90 g/m², or 40 to 70 g/m².
34.A product comprising a translucent or transparent paper according to any of embodiments 1 to 33, wherein the translucent or transparent paper is bonded to a paper or paperboard item.
35. The product comprising a translucent or transparent paper according to embodiment 34, wherein the glue or adhesive is disposed between a paper or paperboard item and the coating layer on the reverse side of the fibrous substrate.
36. The product of embodiment 34, wherein a glue or adhesive is disposed between a paper or paperboard item and the white ink layer.
37. The product of embodiment 35 or 36, wherein the glue or adhesive comprises a material selected from a group consisting of polyurethane adhesives, acrylic adhesives, one or two-component polychloroprene adhesive, polyvinyl acetate, modified starch, methylcellulose, and vinylic dispersion. A particular glue or adhesive is solvent-based two-component polyurethane adhesive containing ADCOTE 548-81R (from DOW EUROPE GmbH) and Ethyl Acetate.
38. The product of any of embodiments 35 to 37, wherein the glue or adhesive is disposed in a layer having a thickness in a range from 2 to 12μm.
39. The process for producing a translucent or transparent paper according to any of embodiments 1 to 38, comprising:
   a) providing or producing a fibrous substrate having a front side and a reverse side, wherein an opacity index of said fibrous substrate is less than or equal to 25% measured in accordance with the ISO 2471 standard;
   b) applying a coating composition, for example, an aqueous coating composition, on the front side of the fibrous substrate, the coating composition comprising a material chosen from the group comprising or consisting of copolymers or homopolymer of vinylidene chloride, such as aqueous dispersion of said copolymers or comopolymer of vinylidene chloride, copolymers or homopolymer of styrene such as aqueous dispersion of copolymers or homopolymer of styrene, such as styrene 1,3-butadiene, copolymers or homopolymer of acrylic, copolymers of homopolymer of polyester, in particular water-based polyester, paraffin such as paraffin wax, and mixtures thereof;
   c) drying the coating composition at a temperature between 70 and 200 ° C. for 0.1 to 1 minute, so as to form a coating layer having a thickness in a range from 1 to 40 μm, preferably from 2 to 20 μm, and even more preferably from 4 to 12 μm; and
   d) optionally repeating steps b) and c) at least once.
40. The process of embodiment 39, wherein the step of applying and drying the coating composition on the reverse side of the fibrous substrate is repeated at least once.
41. The process of any of embodiments 39 to 40, wherein the coating composition comprises an aqueous emulsion or latex of a copolymer or homopolymer of vinylidene chloride.
42. The process of embodiment 41, wherein the coating composition is an aqueous emulsion or latex of polyvinylidene chloride homopolymer.
43. The process of any of embodiments 39 to 42, wherein the coating composition is applied by a technique selected from roll-to-roll coating, blade coating, spray coating, Mayer rod coating, air knife coating, direct gravure, offset gravure, reverse gravure, deep coating, smooth roll coating, curtain coating, bead coating, slot coating, twin HSM coating, film press coating, size press coating, and/or transfer film method, in particular air knife coating and/or reverse gravure coating.
44. The process of any of embodiments 39 to 43, wherein, before step b), a composition for a primer layer is applied on the front side of the fibrous substrate and dried so as to form a primer layer having a thickness in a range from 0.1 to 4 μm, which is disposed between said front side of the fibrous substrate and the coating layer.
45. The process of embodiment 44, wherein the composition for a primer layer comprises a resin and a solvent.
46. The process of embodiment 45, wherein the resin is selected from a group consisting of polyurethane resin, polyamide resin, acrylic resin, alkyd resin, polyester resin, phenolic resin, derivatives of said resins, and any mixtures thereof.
47. The process of embodiment 46, wherein the solvent comprises an organic solvent selected from a group consisting of methanol, ethanol, acetone, iso-propanol, and ethyl acetate.
48. The process of any of embodiments 39 to 47, wherein a layer of optically transparent and electrically conductive material is deposited on at least a portion of the coating layer disposed on the front side and/or the reverse side of the fibrous substrate.
49. The process of any of embodiments 39 to 48, wherein, after step b) or c), the coating composition is also applied on the reverse side of the fibrous substrate and dried so as to form a coating layer having a thickness in a range from 1 to 40 μm, preferably from 2 to 20 μm, and even more preferably from 4 to 12 μm, wherein the coating composition comprises a material chosen from the group consisting of copolymers or homopolymer of vinylidene chloride.
50. The process of any of embodiments 39 to 49, wherein, before applying the coating composition on the reverse side of the fibrous substrate, the composition for the primer layer is applied on said reverse side of said fibrous substrate and dried so as to form a primer layer having a thickness in a range from 0.1 to 4 μm, which is disposed between said reverse side of the fibrous substrate and the coating layer.
51. The process of any of embodiments 39 to 48, wherein a composition for an ink adhesion layer is applied on the reverse side of the fibrous substrate and dried so as to form an ink adhesion layer having a thickness in a range from 0.1 to 4 μm.
52. The process of any of embodiments 39 to 50, wherein a composition for an ink adhesion layer is applied on the exposed face of the coating layer disposed on the reverse side of the fibrous substrate and dried so as to form an ink adhesion layer having a thickness in a range from 0.1 to 4 μm.
53.The process of embodiment 51 or 52, wherein the composition for the ink adhesion layer comprises styrene acrylate, styrene butadiene, polyvinyl Acetate, polyethylene acrylic acid, modified starch, or aqueous emulsion or latex thereof.
54. The process of embodiment 51 or 53, wherein the composition for an ink adhesion layer is applied on the reverse side of the fibrous substrate by a technique selected from roll-to-roll coating, blade coating, spray coating, Mayer rod coating, air knife coating, direct gravure, offset gravure, reverse gravure, deep coating, smooth roll coating, curtain coating, bead coating, slot coating, twin HSM coating, film press coating, size press coating, and/or transfer film method, in particular air knife coating and/or reverse gravure coating.
55. The process of any of embodiments 51 to 54, wherein a feature is printed on the exposed face of the ink adhesion layer or the exposed face of the coating layer disposed on the reverse side of the fibrous substrate in reverse or mirror mode (i.e. left/right reversal) by a technique selected from offset printing, inkjet printing, laser printing, xerographic printing, screen printing, flexographic printing, continuous inkjet, liquid toner printing, letterpress, laser engraving, and/or hot foil blocking, in particular offset printing, inkjet printing, screen printing, continuous inkjet, and/or liquid toner printing.
56. The process of embodiment 55, wherein one or more layers of white ink are applied over the feature by a technique selected from roll-to-roll coating, blade coating, spray coating, Mayer rod coating, air knife coating, direct gravure, offset gravure, reverse gravure, deep coating, smooth roll coating, curtain coating, bead coating, slot coating, twin HSM coating, film press coating, size press coating, transfer film method, offset printing, inkjet printing, laser printing, xerographic printing, screen printing, flexographic printing, continuous inkjet, liquid toner printing, and/or hot foil blocking, especially by screen printing, liquid toner printing, and/or offset printing.
57. A process for producing a product of embodiments 34 to 38 comprising steps according to claims 39 to 56, wherein a glue or adhesive is applied in a layer on the white ink layer or a surface of a paper or paperboard item so as to bond the translucent or transparent paper and the paper or paperboard item.
58. The process of producing a product of embodiments 34 to 38 comprising steps according to claims 39 to 50, wherein the glue or adhesive is further applied in a layer on the coating layer on the reverse side of the fibrous substrate and the paper or paperboard item.
59. The process of embodiment 57 or 58, wherein the glue or adhesive is adhered to a paper or paperboard item.
60. The use of the translucent or transparent paper of embodiments 1 to 59 for packaging, especially luxury packaging, as a transparent or translucent protective tape/strip/ribbon, pocket, wrapper, or a plastic laminate replacement/alternative wherein optionally the packaging is heat sealed when the coating layer of the paper comprises polyvinylidene chloride, in particular homopolymer of vinylidene chloride (PVDC).
61. The transparent or translucent paper or a process for producing such paper according to any of embodiments 1 to 60, wherein the coating layer comprises or consists of polyvinylidene chloride, for example, Diofan A297 from Solvay, and has a dry coat weight in a range of 4 to 21 g/m² of the fibrous substrate, in particular, 8.5 to 21 g/m², or 9 to 14 g/m², or 8 to 13 g/m², 6 to 12 g/m², or 7 to 12 g/m², or 5 to 11 g/m², or 7 to 11 g/m², or 8 to 9.5 g/m², or 10 to 12 g/m², for example, 5 to 11g/m² on the front side and 7 to 11 g/m² on the reverse side.
62. The transparent or translucent paper or a process for producing such paper according to any of embodiments 1 to 60, wherein the coating layer comprises or consists of an acrylic polymer, for example, Galacryl 80.330.05 from Schmid Rhyner, and has a dry coat weight in a range of 4 to 12 g/m², for example, 5 to 9 g/m², or 7 to 8 g/m².
63. The transparent or translucent paper or a process for producing such paper according to any of embodiments 1 to 60, wherein the coating layer comprises or consists of a polymer based on styrene-butadiene, in particular, styrene 1,3-butadiene, for example, Epotal SP-106 D from BASF, and has a dry coat weight in a range of 3 to 12 g/m², for example, 3 to 10 g/m², or 5 to 11 g/m², or 7 to 11 g/m².
64. The translucent or transparent paper of embodiments 1 to 60 comprising (i) a fibrous substrate having a basis weight of 42, 52, 62, 63.5, 82, 102, 112, 140, or 180 g/m², and (ii) a coating layer comprising or consisting of polyvinylidene chloride, for example, Diofan A297 from Solvay, and having a dry coat weight in a range of 4 to 21 g/m² of the fibrous substrate, in particular, 8.5 to 21 g/m², or 9 to 14 g/m², or 8 to 13 g/m², 6 to 12 g/m², or 7 to 12 g/m², or 5 to 11 g/m², or 7 to 11 g/m², or 8 to 9.5 g/m², or 10 to 12 g/m², for example, 5 to 11g/m² on the front side and 7 to 11 g/m² on the reverse side.
65. The translucent or transparent paper of embodiments 1 to 60 comprising (i) a fibrous substrate having a basis weight of 42, 52, 62, 102, or 112 g/m², and (ii) a coating layer comprising or consisting of an acrylic polymer, for example, Galacryl 80.330.05 from Schmid Rhyner, and having a dry coat weight in a range of 4 to 12 g/m², for example, 5 to 9 g/m², or 7 to 8 g/m².
66. The translucent or transparent paper of embodiments 1 to 60 comprising (i) a fibrous substrate having a basis weight of 42, 62, 82, 102, 112, 180 g/m², and (ii) a coating layer comprising or consisting of a polymer based on styrene-butadiene, in particular, styrene 1,3-butadiene, for example, Epotal SP-106 D from BASF, and having a dry coat weight in a range of 3 to 12 g/m², for example, 3 to 10 g/m², or 5 to 11 g/m², or 7 to 11 g/m².

The invention advantageously may in addition to the disclosed properties above enable decreasing the roughness (Bendsten roughness) of the fibrous substrate when the coating layer has been applied on said substrate. This additional result may be obtained depending on the coating process which is used. As a result according to a particular embodiment of the invention, the roughness of the coated face or faces may be less than 120 ml/mn, in particular may be in the range of about 70 ml/mn.

Terms and phrases used in the present invention and in particular for the definition of the particular embodiments and the examples generally have meaning ordinary to those skilled in the art. In addition, the following terms are given the particular meaning as defined below. Such particular definition may be considered in combination with the ordinary meaning used by those skilled in the art.

The “translucent or transparent paper” of the present invention means a paper material or a paper object obtained from pulp fibers forming a fibrous substrate and is provided as a planar element, in particular a thin planar element such as a sheet of paper, having an opacity or transparency as disclosed herein, including in accordance with the particular embodiments of the Examples. The translucent or transparent paper of the present invention does not contain a plastic film, and thus is recyclable and/or repulpable. Other specific features of the transparent or translucent paper of the invention are disclosed herein.

The term “opacity” describes an extent to which an object, in particular a paper sheet, is seen through as some the light is not allowed to travel through the object. Opacity may be considered as inversely proportional to transparency. Opacity or transparency of a paper sheet can be measured by an apparatus known in the field, such as a spectrophotometer NOVICOLOR N5950.

The “fibrous substrate” as used herein refers to a material or object, in particular a sheet based on fibrous substrate, in particular a paper material or object, especially a paper sheet, and generally comprises vegetal fibers, cellulose fibers, in particular wood cellulose fibers, which are especially obtained from sustainable and environmentally friendly sources and processes. The fibrous substrate is advantageously translucent. Preferably, the fibrous substrate is a tracing paper, in particular natural tracing paper. Natural tracing paper derives its translucency primarily from the unusually high degree of refining of the cellulose pulp fibers from which it is made. This results in a sheet without the air/fiber interfaces that give most papers their opacity. The translucency of natural tracing paper does not come from impregnation with an oil or other transparentizing chemical. The natural tracing paper may be a modified natural tracing paper that has improved folding endurance, greater resistance to tearing, greater stretch ability under tensile loading before a break occurs, reduced tensile strength and reduced stiffness, such as a urea-treated natural tracing paper as disclosed in European patent application EP1306484. Alternatives to a fibrous substrate consisting of tracing paper may encompass glassine paper, impregnated paper, and parchment paper or any paper substrate having basically transparent or translucent properties. Prepared tracing paper such as one treated with sulfuric acid may also be used as a translucent fibrous substrate.

According to the invention, at least one side of the fibrous substrate as defined above and in particular when it consists of a tracing paper is covered by a coating layer having a transparentization property and/or barrier properties including a moisture barrier property. The other side of the fibrous substrate may in particular be either a) bonded to a paper or paperboard item, b) printed with a feature before being bonded to a paper or paperboard item, or c) covered with the same coating layer. In case of c), the resulting translucent or transparent paper may be used as a sheet, tape/strip/ribbon or wrapper or any other suitable format of a translucent or transparent paper that replaces plastic materials. The paper or paperboard item disclosed herein may comprise a printed feature, which may be covered (i.e. by bonding or lamination) by the transparent or translucent paper of the invention so that the printed feature is protected from moisture, grease and mechanical abrasion while visible through said transparent or translucent paper.

The terms “repulpable paper” and “recyclable paper” refer to the ability to reuse the paper as a raw material for producing a new paper. Different methods may be used to characterize the repulpability and recyclability of a paper. A repulpable paper can undergo repulping operations including re-wetting and fiber recovery for subsequent sheet formation. The coating layer provided on a repulpable paper is readily separable from paper fibers or dispersible during the repulping operation, enabling recovery of paper fibers. The repulped fibers are then used to prepare recycled papers.

The repulpability and recyclability of a paper are evaluated according to a method described in “Voluntary standard for repulping and recycling corrugated fiberboard treated to improve its performance in the presence of water and water vapor” revised Aug. 16, 2013 and/or Tappi Test Method T275 sp-12. Under conditions specified therein, a Somerville-type equipment may be used to separate the pulped material in a screen with slit width of 0.01-inch or smaller to determine fiber recovery as a percentage of the amount of fiber charged. The fiber yield from the repulpability test must be at least 80% based on the total fiber weight, or 85% based on the bone dry fiber charged to the pulper.

The term “coating layer” refers to a dry or dried layer of material(s) provided on at least the front side of the fibrous substrate by coating. The front side of the fibrous substrate is the side which faces the manufacturer or user when displayed. The coating layer disposed on the front side of the fibrous substrate comprises a material that is suitable to provide barrier properties against moisture, oxygen and other gases when applied as a coating on the fibrous substrate. The coating layer is additionally regarded as a “transparentization layer” as the coating advantageously alleviates surface irregularities or roughness of the fibrous substrate, which significantly reduces the amount of light scattered off the surface of the fibrous substrate. The transparentizing property/function of the coating layer may also come from the reduced surface inhomogeneity present due to a refractive index mismatch between air bubbles and fibrous, in particular cellulose fibers. In such case, the refractive index of the coating layer is the same or very close to that of cellulose fibers thereby reducing the light scattering ability of the fibrous substrate. The coating layer may also penetrate into the fibrous substrate, thereby reducing any residual light scattering linked to the core/bulk of said fibrous substrate. The coating layer provided on the reverse side of the fibrous substrate may or may not be of the same nature but in any case serves the purpose of transparentizing the fibrous substrate in such a way described above. For example, an ink adhesion layer provided on the reverse side may be regarded as a coating layer of a different nature as long as it fulfills the purpose of transparentizing the fibrous substrate in such a way described above. Nevertheless, unless otherwise indicated, the coating layer provided on the reverse side of the fibrous substrate is of the same nature (i.e. same composition) as the coating layer provided on the front side of the fibrous substrate. Whenever the coating layer provided on the reverse side of the fibrous substrate is an ink adhesion layer having an ink adhesion property, it is clearly indicated so.

The coating layer may comprise a textured surface which is haptically perceptible. This can be achieved by the addition of chemicals which change the friction coefficient and/or particles which modify the roughness or the softness of the surface according to the rigidity and size of the particles.

The coating layer may comprise materials that are not necessarily renewable. In such case, the mass the non-renewable material comprised in the coating layer is very low relative to the total mass of the cellulose fibers in the translucent or transparent paper. This allows the translucent or transparent paper to be repulpable and/or recyclable.

The commercial products that can be used as or comprised in the coating layer include Diofan A297 from Solvay (aqueous emulsion of polyvinylidene chloride), Epotal SP-106D from BASF (aqueous dispersion of Styrene 1,3-butadiene), Galacryl 80.330.05 from Schmid Rhyner (Acrylic polymer), VaporCoat 2200 from Michelman (Acrylic polymer), Evcote 3050 from Akzo Nobel (Water based polyester) Cartaseal VWF Liquid from Archroma (acrylic polymer), MYSTOLENE PS from Catomance Technologies (paraffin wax and rosin), and AQUACER 497 from BYK Additives& Instruments (non-ionic aqueous emulsion of a paraffin wax). In a particular embodiment, the coating layer may additionally include SiOx deposition by vacuum deposition or Atomic Layer Deposition such as Ceramis from Armcor and/or Chromatogenie from Centre Technique du papier Grenoble (fatty acid grafted on the paper by gas chemical reaction).

Coating is performed according to any method well known in the art such as roll-to-roll coating, blade coating, spray coating, Mayer rod coating, air knife coating, direct gravure, offset gravure, reverse gravure, deep coating, smooth roll coating, curtain coating, bead coating, slot coating, twin HSM coating, film press coating, size press coating, or transfer film method.

The term “exposed face” refers to a face of the coating layer, the ink adhesion layer, the primer layer, the printed feature, or any other layer or deposit located opposite the fibrous substrate (i.e. the exposed face is not in directly contact with or facing away from the fibrous substrate). In a particular embodiment, the exposed face may be the front side of the translucent or transparent paper.

The term “primer layer” refers to a dry or dried layer of material optionally provided underneath the coating layer such that the primer layer is disposed or coated between the fibrous substrate and the coating layer in order to improve the spreadability of the coating composition that subsequently forms the coating layer when dried.

According to an embodiment of the invention, the optically transparent and electrically conductive material may be comprised within the coating layer (e.g., mixed with the coating layer composition) or may form a sub-layer of the coating layer.

The term “sub-layer” refers to a layer that is provided in conjunction with another layer. When the coating layer comprises a sub-layer of optically transparent and electrically conductive material, the sub-layer of optically transparent and electrically conductive material may be disposed on the outermost face of the coating layer (i.e. the side facing away from or opposite the fibrous substrate), beneath the coating layer (i.e. in contact with the fibrous substrate or the primer layer), or within the coating layer (i.e. buried in or surrounded by the coating layer).

The optically transparent and electrically conductive material is optionally disposed in conjunction with the coating layer and may form a continuous layer having a surface area of from a few square millimeters up to tens of square centimeters. Such continuous layer may serve as an electrode in applications such as photovoltaics.

The optically transparent and electrically conductive material is optionally disposed in conjunction with the coating layer and may form one or more continuous traces having a width of microscopic scale, in particular a few micrometers, and a length in a range from a few micrometers up to a few centimeters or tens of centimeters. In particular, it may be arranged as tracks. Said one or more continuous traces may serve as antenna(s) for RFID or NFC applications.

The layer or trace(s) of optically transparent and electrically conductive material may be formed by various coating or printing techniques known to those skilled in the art, depending on the viscosity of such optically transparent and electrically conductive material provided or formulated by those skilled in the art.

The term “ink adhesion layer” refers to a layer that ensures adhesion of an ink when a feature is required to be printed so that a desired printing quality can be achieved for various applications. The ink adhesion layer may alternatively be referred as a “printable layer” or “ink adhesion promoter layer”. The ink adhesion layer is advantageously transparent. Preferably, the ink adhesion layer also acts as a “transparentization layer” when applied on the reverse side of the fibrous substrate and alleviates surface irregularities or roughness of the fibrous substrate, which significantly reduces the amount of light scattered off the surface of the fibrous substrate. The ink adhesion layer may thus be regarded as a coating layer of different nature. The ink adhesion layer may have the same or very close refractive properties to that of cellulose fibers thereby reducing the light scattering ability of the fibrous substrate. The ink adhesion layer may also penetrate into the fibrous substrate, thereby reducing any residual light scattering linked to the core/bulk of said fibrous substrate.

The ink adhesion layer may be disposed directly on the reverse side of the fibrous substrate or on a coating layer provided on the reverse side of the fibrous substrate.

The “printed feature” refers to any image or text printed in color or black and white, using various printing techniques including, but not limited to, offset printing, inkjet printing, laser printing, xerographic printing, screen printing, flexographic printing, continuous inkjet, liquid toner printing, letterpress, laser engraving, and hot foil blocking.

The printed feature may be disposed on the reverse side of the fibrous substrate in various modes: (a) directly on the fibrous substrate, (b) on a coating layer that is disposed on the fibrous substrate or on a primer layer, or (c) on an ink adhesion layer that is disposed on the fibrous substrate or on a coating layer.

The printed feature is advantageously printed in a reverse or mirror mode (i.e. left/right reversal) so that the printed feature can be readable from the front side of the transparentized fibrous substrate or the translucent or transparent paper.

By printing on the reverse side of the fibrous substrate, the printed feature can be protected from any external factors such as moisture, oxygen, grease and scratches.

The “white ink” is advantageously disposed on the printed feature so as to cover the printed feature and preferably disposed on the entirety of the reverse side of the fibrous substrate over the printed feature. The white ink increases contrast of the printed feature, which is viewed from the front side of the fibrous substrate or the translucent or transparent paper.

The invention also relates to a product that comprises the translucent or transparent paper according to the invention bonded to a paper or paperboard item by any available technique, in particular laminated with said paper or paperboard item. The paper or paperboard item may be a folded paper box, an assembled box or case made from hard paperboard, or a bag made of paper, paperboard or cardboard.

The translucent of transparent paper of the invention may be bonded to a standard paper, cardboard or paperboard (generally designated as a paper support) printed with a feature with a layer of glue or adhesive disposed in between the two.

The glue, which may be referred as an adhesive is used to bond the translucent or transparent paper of the invention, which may or may not comprise a printed feature on the reverse side of the fibrous substrate, to any paper or paperboard items.

The glue or adhesive is preferably transparent or white and applied in a continuous layer so as to ensure that no air bubbles or gaps are created between the translucent or transparent paper and the item or the object to which said translucent or transparent paper is adhered. The glue or adhesive advantageously has good moisture barrier properties.

Additional features and details appear in the following examples and in the figure. Throughout the examples, natural tracing paper was used to demonstrate specific embodiments of the invention.

### BRIEF DESCRIPTION OF THE DRAWINGS

FIG. 1 discloses the hygroexpansivity of coated tracing paper of Example 6 measured by a Varidim apparatus.

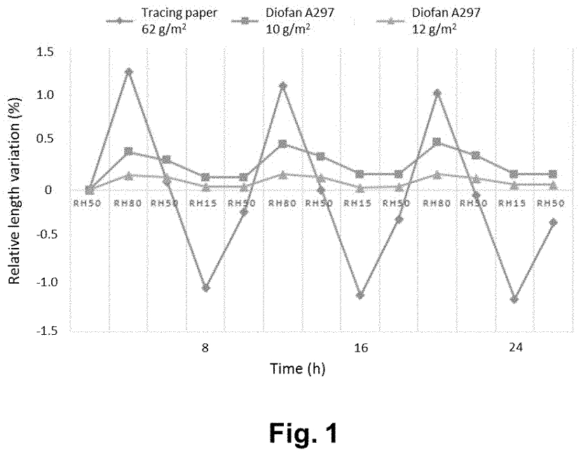

### DESCRIPTION OF THE PREFERRED EMBODIMENTS

Example 1: A sheet of coated paper having a basis weight of 115 g/m² (obtained from Satimat) was printed by xerography in black, and a tracing paper was bonded against the printed feature with solvent-based two-component polyurethane adhesive containing ADCOTE 548-81 R (from DOW EUROPE GmbH) and Ethyl Acetate. The brightness of the printed feature was measured with a spectrophotometer NOVICOLOR N5950 under ISO 2469 through the tracing paper before and after the application of a coating layer by a Mayer rod. Tracing papers having different basis weights (or grammages) were coated with different coating compositions at different coat weights. Dry coat weight of each coating composition was obtained after drying. The Galacryl 80.330.05 is an acrylic glossy varnish. The Diofan A297 is an aqueous emulsion of polyvinylidene chloride. The obtained values are as follows:

| Basis weight | | Dry Coat | Brightness | Brightness |
|---|---|---|---|---|
| of tracing | | weight | before | after |
| paper (g/m²) | Coating layer | (g/m²) | coating | coating |
| 42 | DIOFAN A 297 | 9.4 | 9.2 | 7.7 |
| 42 | GALACRYL | 8.2 | 7.8 | 4.6 |
| | 80.330.05 | | | |
| 62 | DIOFAN A 297 | 7.6 | 9.3 | 8.1 |
| 62 | GALACRYL | 7.0 | 10.8 | 8.4 |
| | 80.330.05 | | | |
| 102 | GALACRYL | 7.3 | 10.0 | 7.1 |
| | 80.330.05 | | | |

The lower the brightness of the printed feature was, the darker the shade of the printed feature was through the tracing paper. It was observed that the thinner the tracing paper was, the lower the brightness of the printed feature was. The brightness of the printed feature measured through the tracing paper was lower after coating; in other words, the printed feature was more visible after coating due to transparentization of the tracing paper. Galacryl 80.330.05 and Diofan A297 improved the visibility of the printed feature. Note that the brightness of the printed feature through tracing paper was consistently reduced as transparency of the tracing paper was improved regardless of the brightness of the printed feature provided before coating.

Example 2: Two tracing paper sheets, having a basis weight of 82 g/m² and 112 g/m² were printed by a four-color offset printing press Sakurai LED UV and covered with a white print applied by screen printing. The inks used were Xcura Black, Cyan, Magenta, and Yellow. The ink densities for 100% ink coverage were between 1.2 and 1.5 for black, 1 and 1.1 for cyan, 0.9 and 1 for magenta, and 0.8 and 0.9 for yellow. A transparentization layer was coated on the non-printed side by Mayer rod coating. The brightness of the 100% black print measured through the paper is as follows:

| | Dry Coat | |
|---|---|---|
| | Weight | Offset |
| material | (g/m²) | Brightness |
| Tracing paper 82 gsm | | |
| no layer | 0 | 8.5 |
| Diofan A 297 | 6.2 | 8 |
| Diofan A 297 | 11.8 | 5.9 |
| Epotal SP-106 D | 3.2 | 7.9 |
| Epotal SP-106 D | 7.1 | 7.6 |
| Epotal SP-106 D | 10 | 7 |
| Tracing paper 112 gsm | | |
| no layer | 0 | 11.8 |
| Diofan A 297 | 7.9 | 9.2 |
| Diofan A 297 | 13.1 | 8.7 |
| Epotal SP-106 D | 7.4 | 9.8 |
| Epotal SP-106 D | 11.2 | 9.4 |

The inventors observed that the brightness measured over the black print was reduced when any one of the coating layer compositions Diofan A297 or Epotal SP-106 D was applied. The printed feature was visually distinct through the tracing paper. The best result was obtained with the thinnest (i.e. having the lowest basis weight) tracing paper.

Example 3: Two sides of two tracing paper sheets, having a basis weight of 112 g/m² and 180 g/m², were applied with an adhesion promoter for liquid toner ink. These sheets were printed by liquid toner using HP Indigo 7800 press. The image formed by 4 colors was covered by two layers of 100% white ink. The non-printed side was coated with a transparentization layer by Mayer rod coating. The brightness of the 100% black print is as follows:

| | Dry Coat | liquid |
|---|---|---|
| | Weight | Toner |
| material | (g/m²) | Brightness |
| Tracing paper 112 gsm | | |
| no layer | 0 | 11.6 |
| Diofan A 297 | 5.2 | 10.6 |
| Diofan A 297 | 10.6 | 9.7 |
| Epotal SP-106 D | 5.5 | 11.2 |
| Epotal SP-106 D | 11.2 | 10.1 |
| Galacryl 80,330,05 | 4.7 | 9.8 |
| Galacryl 80,330,05 | 9 | 8.4 |
| Tracing paper180 gsm | | |
| no layer | 0 | 11.7 |
| Diofan A 297 | 6.4 | 11.2 |
| Diofan A 297 | 11.4 | 9.9 |

Example 4: A coating was applied on a side of a tracing paper having a basis weight of 52 g/m² using a Mayer rod. On the one hand, a product Galacryl 80.330.05 was applied at 11.3 g/m². On the other hand, 12.9 g/m² of a product Diofan A297 was applied. The water vapor transmission rate was achieved in accordance with the test method ISO 2528 under which the sample was placed at 23° C. with an atmosphere of 85% RH on one side and a desiccant on the other (0% RH).

| | Water vapor transmission | |
|---|---|---|
| | rate (g/m²/day) | Opacity index |
| Tracing paper only | 23.7 | 28.8 |
| With a layer of Galacryl | 15.3 | 17.8 |
| 80.330.05 | | |
| With a layer of Diofan | 3.3 | 18.9 |
| A297 | | |

Example 5: A coating of Diofan A297 (from Solvay) was deposited to achieve several different dry coat weights between 8 and 22 g/m² per side on both sides of a tracing paper having a basis weight of 62 g/m² (from Arjowiggins). Drying was carried out at 120 ° C. The table below shows the opacity index of the sheets.

| | Dry Coat Weight (g/m²) | |
|---|---|---|
| Sample | (per side) | Opacity index |
| Tracing paper only | — | 25.3 |
| coating Diofan A 297 | 8.5 | 17 |
| coating Diofan A 297 | 10 | 17 |
| coating Diofan A 297 | 12 | 14.5 |
| coating Diofan A 297 | 14 | 16.5 |
| coating Diofan A 297 | 21 | 11.7 |

A very sharp drop in opacity was observed beyond expectations, as it was possible to reduce the opacity of the tracing paper by about 2.2 times. Example 6: The table below shows hygroexpansivity of two tracing papers having a basis weight of 62 g/m², each coated with Diofan A 297 with a coat weight of 10 g/m² and 12 g/m². The hygroexpansivity/dimensional variations (measured along the cross-grain direction) were obtained by using a Varidim apparatus, which measured the variation of dimensions in function of different humidity cycles.

| | Varidim | | | | | | | | | | | | |
|---|---|---|---|---|---|---|---|---|---|---|---|---|---|
| | Relative length variation (%) | | | | | | | | | | | | |
| Relative | RH | RH | RH | RH | RH | RH | RH | RH | RH | RH | RH | RH | RH |
| Humidity | 50 | 80 | 50 | 15 | 50 | 80 | 50 | 15 | 50 | 80 | 50 | 15 | 50 |
| Tracing | 0 | 1.25 | 0.08 | −1.04 | −0.24 | 1.1 | 0 | −1.12 | −0.31 | 1.02 | −0.06 | −1.16 | −0.35 |
| 62 g/m² | | | | | | | | | | | | | |
| Diofan A297 | 0 | 0.4 | 0.31 | 0.13 | 0.13 | 0.48 | 0.35 | 0.16 | 0.16 | 0.5 | 0.36 | 0.16 | 0.16 |
| 10 g/m² | | | | | | | | | | | | | |
| Diofan A297 | 0 | 0.15 | 0.13 | 0.03 | 0.03 | 0.16 | 0.13 | 0.02 | 0.03 | 0.16 | 0.12 | 0.05 | 0.05 |
| 12 g/m² | | | | | | | | | | | | | |

For the standard tracing paper, the peak-to-peak variations were 2.3% (1.25 +1.04 for example for the two first peaks) while for the tracing paper coated with Diofan A297 the peak-to-peak variations were only 0.12% (0.15-0.03), which corresponds to a dimensional variation reduced by a factor of 19.

Example 7: A coating of Diofan A297 was applied on a side of three tracing papers, having a basis weight of 42 g/m², 102 g/m² and 140g/m², using a Mayer rod. The resulting opacity is summarized as follows:

| | Coat Weight | | Coat Weight | |
|---|---|---|---|---|
| | (front side | | (reverse side) | |
| material | (g/m²) | Opacity | (g/m²) | Opacity |
| Tracing paper 42 gsm | | | | |
| no layer | 0 | 25.8 | | |
| Diofan A 297 | 5.3 | 21.9 | 7.2 | 17.9 |
| Diofan A 297 | 11.3 | 19.7 | 10.9 | 17 |

| | | Translucent |
|---|---|---|
| | Coat Weight | 102 gsm |
| material | (g/m²) | Opacity |
| Translucent 102 gsm | | |
| no layer | 0 | 32.3 |
| Diofan A 297 | 7.1 | 28.7 |
| Diofan A 297 | 11.5 | 27.6 |
| Translucent 140 gsm | | |
| no layer | 0 | 42.6 |
| Diofan A 297 | 9 | 39.7 |
| Diofan A 297 | 14.1 | 38.5 |

The inventors observed that the thinner the tracing paper was, the less opaque was the resulting paper. The thicker the coating layer was, the greater was the decrease in opacity.

The inventors surprisingly observed a very sharp decline in the opacity that exceeded their expectations, as they managed to decrease the opacity by a factor of 2.2.

Example 8: A tracing paper possessing the following characteristics was used in this example:

| measure | method | Unit | value |
|---|---|---|---|
| Grammage | ISO 536 | g/m² | 63.5 |
| Caliper | ISO 534 | μm | 56.0 |
| Moisture | ISO 287 | % | 7.8 |
| Tear MD | ISO 1974 | daN | 144 |
| Tear CD | ISO 1974 | daN | 176 |
| Contrast Ratio | ISO 2469 | | 18.1 |
| Whiteness | ISO 5631-2 | | 56.5 |
| Colour L | ISO 5631-2 | | 85.4 |
| a | ISO 5631-2 | | −0.5 |
| b | ISO 5631-2 | | 2.0 |
| Burst | ISO 2758 | kPa | 272 |
| Fold MD | ISO 5626 | | 2085 |
| Fold CD | ISO 5626 | | 826 |
| Surface pH | TAPPI 529OM/ISO | | 6.6 |
| | 6588 | | |
| Stiffness MD | ISO 2493-2 | mN | 22.9 |
| Stiffness CD | ISO 2493-2 | mN | 8.9 |
| Roughness Top | ISO 8791-2 | mL/mn | 115 |
| Roughness Back | ISO 8791-2 | mL/mn | 101 |

The water vapor transmission rate, achieved in accordance with the test method TAPPI/ANSI T 464 om-12 under which the sample to test was placed at 37.8° C. with an atmosphere of 90% RH on one side and a desiccant on the other, was 96.5 g/m²/day. The opacity was 26%.

The tracing paper was coated on a reel by smooth roll coating method. The coating layer was applied on both sides (the front side and the reverse side) with an amount of 4 g/m² per side.

When the applied coating layer was a protection varnish, the water vapor transmission rate was 47.1 g/m²·day. The opacity was 20.2%.

When the applied coating layer was a dried aqueous emulsion of polyvinylidene chloride (PVDC), the water vapor transmission rate was 16.8 g/m²·day. The opacity was 24.4% and the tracing paper was repulpable.

1. A translucent or transparent paper comprising:
(i) a fibrous substrate having a front side and a reverse side, the opacity index of said fibrous substrate being less than or equal to 45% measured in accordance with the ISO 2471 standard; and
(ii) one or more coating layers, in particular one or two coating layers disposed on the front side of said fibrous substrate, comprising a material conferring moisture barrier properties, having transparentization capability when provided as a coating layer on said fibrous substrate, and enabling the translucent or transparent paper to be repulpable, in particular said material being selected from the group consisting of copolymers or homopolymer of vinylidene chloride, copolymers or homopolymer of styrene copolymers or homopolymer of acrylic, copolymers or homopolymer of polyester, paraffin, and mixtures thereof,
wherein said one or more coating layers on one side of the fibrous substrate have a dry coat weight in a range of from 1 to 40 g/m².

2. The translucent or transparent paper of claim 1, wherein one or more coating layers are also disposed on the reverse side of the fibrous substrate.

3. The translucent or transparent paper of claim 1 having at least one of the following features or combination thereof: (i) a hygroexpansivity less than or equal to 1%, when changing Relative Humidity (RH) from 15% to 80% then to 15% in 8 hours, or (ii) a water vapor transmission rate at 85% RH and 23 ° C. less than or equal to 20 g/m²/day, or less than or equal to 10 g/m²/day, or less than or equal to 5 g/m²/day.

4. The translucent or transparent paper of claim 1, having an opacity index less than or equal to 20% measured in accordance with the ISO 2471 standard.

5. The translucent or transparent paper of claim 1, wherein the fibrous substrate has a basis weight in a range from 40 to 200 g/m2, in particular in a range from 40 to 140 g/m².

6. The translucent or transparent paper of claim 1, wherein the fibrous substrate comprises cellulose fibers refined to above 40 ° SR.

7. The translucent or transparent paper of claim 1, wherein the fibrous substrate is a tracing paper.

8. The translucent or transparent paper of claim 1, wherein one or more coating layers on one side of the fibrous substrate have a total dry coat weight in a range from 1 to 20 g/m².

9. The translucent or transparent paper of claim 1, wherein at least one coating layer comprises a copolymer or homopolymer of vinylidene chloride, in particular a dried latex film of a copolymer of vinylidene chloride or homopolymer of vinylidene chloride (PVDC).

10. The translucent or transparent paper of claim 1, wherein an ink adhesion layer is disposed on the reverse side of the fibrous substrate, the ink adhesion layer having a thickness in a range from 0.1 to 4 μm, in particular an ink adhesion layer comprising any of styrene acrylate, styrene butadiene, polyvinyl acetate, polyethylene acrylic acid, modified starch, or a combination thereof.

11. The translucent or transparent paper of claim 10, wherein at least a portion of the exposed face of the ink adhesion layer disposed on the reverse side of the fibrous substrate comprises a printed feature, which is laterally inverted so that the feature is readable from the exposed face of the coating layer disposed on the front side of the fibrous substrate and through the fibrous substrate.

12. The translucent or transparent paper of claim 11, wherein one or more layers of white ink are disposed on the printed feature or the entirety of the reverse side of the fibrous substrate comprising said printed feature.

13. A product comprising a translucent or transparent paper according to claim 2, wherein the translucent or transparent paper is bonded to a paper, cardboard or paperboard item, with a layer of glue or adhesive disposed between said paper, cardboard or paperboard item and the coating layer(s) on the reverse side of the fibrous substrate, said glue or adhesive having a thickness in a range from 2 to 12 μm, in particular a glue or adhesive comprising a material selected from polyurethane adhesives, acrylic adhesives, one or two-component polychloroprene adhesive, polyvinyl acetate, modified starch, methylcellulose, vinylic dispersion, and mixtures thereof.

14. A process for producing a translucent or transparent paper, comprising:
a) providing or producing a fibrous substrate having a front side and a reverse side, wherein the opacity index of said fibrous substrate is less than or equal to 45% measured in accordance with the ISO 2471 standard;
b) applying a coating composition on the front side of the fibrous substrate, the coating composition comprising a material chosen from material conferring moisture barrier properties and having transparentization capability when provided as a coating layer on said fibrous substrate and enabling the translucent or transparent paper to be repulpable, in particular said material being selected from the group consisting of copolymers or homopolymer of vinylidene chloride, copolymers or homopolymer of styrene copolymers or homopolymer of acrylic, copolymers or homopolymer of polyester, paraffin and mixtures thereof;
c) drying the coating composition at a temperature between 70 and 200° C. for 0.2 to 1 minute, so as to form a coating layer having a thickness in a range from 1 to 40 μm;
d) optionally repeating steps b) and c) at least once; and
e) optionally also applying and drying said coating composition on the reverse side of the fibrous substrate at least once, and/or applying and drying a composition for an ink adhesion layer on the reverse side of the fibrous substrate or on the coating layer(s) disposed on the reverse side,
in particular wherein said coating composition and a composition for a ink adhesion layer are applied by a technique selected from roll-to-roll coating, blade coating, spray coating, Mayer rod coating, air knife coating, direct gravure, offset gravure, reverse gravure, deep coating, smooth roll coating, curtain coating, bead coating, slot coating, twin HSM coating, film press coating, size press coating, and/or transfer film method, in particular air knife coating and/or reverse gravure coating.

15. The process of claim 14, wherein a feature is printed on the exposed face of the ink adhesion layer or the exposed face of the coating layer disposed on the reverse side of the fibrous substrate in reverse or mirror mode (i.e. left/right reversal) by a technique selected from the group consisting of offset printing, inkjet printing, laser printing, xerographic printing, screen printing, flexographic printing, continuous inkjet, liquid toner printing, letterpress, laser engraving, hot foil blocking, and combinations thereof.

16. The process of claim 15, wherein one or more layers of white ink are applied over the printed feature by a technique selected from the group consisting of roll-to-roll coating, blade coating, spray coating, Mayer rod coating, air knife coating, direct gravure, offset gravure, reverse gravure, deep coating, smooth roll coating, curtain coating, bead coating, slot coating, twin HSM coating, film press coating, size press coating, transfer film method, offset printing, inkjet printing, laser printing, xerographic printing, screen printing, flexographic printing, continuous inkjet, liquid toner printing, hot foil blocking, and combinations thereof.

17. A process for producing a product of claim 13 comprising carrying out the steps of the process according to claim 14, further comprising applying a layer of glue on the coating layer and/or a surface of a paper, cardboard or paperboard item so as to bond the translucent or transparent paper and the paper, cardboard or paperboard item.

18. A method for packaging, as a transparent or translucent protective ribbon, pocket, wrapper, or a plastic laminate replacement/alternative, comprising providing the translucent or transparent paper of claim 1, and heat sealing the packaging when the coating layer of the paper comprises a copolymer or homopolymer of vinylidene chloride.

19. The translucent or transparent paper of claim 2, wherein an ink adhesion layer is disposed on the exposed face of the coating layer(s) that is/are provided on the reverse side of the fibrous substrate, the ink adhesion layer having a thickness in a range from 0.1 to 4 μm, in particular an ink adhesion layer comprising any of styrene acrylate, styrene butadiene, polyvinyl acetate, polyethylene acrylic acid, modified starch, or a combination thereof.

20. The translucent or transparent paper of claim 2, wherein at least a portion of the exposed face of the coating layer disposed on the reverse side of the fibrous substrate comprises a printed feature, which is laterally inverted so that the feature is readable from the exposed face of the coating layer disposed on the front side of the fibrous substrate and through the fibrous substrate.

21. The translucent or transparent paper of claim 20, wherein one or more layers of white ink are disposed on the printed feature or the entirety of the reverse side of the fibrous substrate comprising said printed feature.

22. The translucent or transparent paper of claim 19, wherein at least a portion of the exposed face of the ink adhesion layer comprises a printed feature, which is laterally inverted so that the feature is readable from the exposed face of the coating layer disposed on the front side of the fibrous substrate and through the fibrous substrate.

23. The translucent or transparent paper of claim 22, wherein one or more layers of white ink are disposed on the printed feature or the entirety of the reverse side of the fibrous substrate comprising said printed feature.

24. A product comprising a translucent or transparent paper according to claim 11, wherein the translucent or transparent paper is bonded to a paper, cardboard or paperboard item, with a layer of glue or adhesive disposed between said paper, cardboard or paperboard item and the printed feature on the reverse side of the fibrous substrate, said glue or adhesive having a thickness in a range from 2 to 12 μm, in particular a glue or adhesive comprising a material selected from the group consisting of polyurethane adhesives, acrylic adhesives, one or two-component polychloroprene adhesive, polyvinyl acetate, modified starch, methylcellulose, vinylic dispersion, and mixtures thereof.

25. A product comprising a translucent or transparent paper according to claim 20, wherein the translucent or transparent paper is bonded to a paper, cardboard or paperboard item, with a layer of glue or adhesive disposed between said paper, cardboard or paperboard item and the printed feature on the reverse side of the fibrous substrate, said glue or adhesive having a thickness in a range from 2 to 12 μm, in particular a glue or adhesive comprising a material selected from the group consisting of polyurethane adhesives, acrylic adhesives, one or two-component polychloroprene adhesive, polyvinyl acetate, modified starch, methylcellulose, vinylic dispersion, and mixtures thereof.

26. A product comprising a translucent or transparent paper according to claim 22, wherein the translucent or transparent paper is bonded to a paper, cardboard or paperboard item, with a layer of glue or adhesive disposed between said paper, cardboard or paperboard item and the printed feature on the reverse side of the fibrous substrate, said glue or adhesive having a thickness in a range from 2 to 12 μm, in particular a glue or adhesive comprising a material selected from the group consisting of polyurethane adhesives, acrylic adhesives, one or two-component polychloroprene adhesive, polyvinyl acetate, modified starch, methylcellulose, vinylic dispersion, and mixtures thereof.

27. A product comprising a translucent or transparent paper according to claim 12, wherein the translucent or transparent paper is bonded to a paper, cardboard or paperboard item, with a layer of glue or adhesive disposed between said paper, cardboard or paperboard item and the white ink layer(s) on the reverse side of the fibrous substrate, said glue or adhesive having a thickness in a range from 2 to 12 μm, in particular a glue or adhesive comprising a material selected from the group consisting of polyurethane adhesives, acrylic adhesives, one or two-component polychloroprene adhesive, polyvinyl acetate, modified starch, methylcellulose, vinylic dispersion, and mixtures thereof.

28. A product comprising a translucent or transparent paper according to claim 21, wherein the translucent or transparent paper is bonded to a paper, cardboard or paperboard item, with a layer of glue or adhesive disposed between said paper, cardboard or paperboard item and the white ink layer(s) on the reverse side of the fibrous substrate, said glue or adhesive having a thickness in a range from 2 to 12 μm, in particular a glue or adhesive comprising a material selected from the group consisting of polyurethane adhesives, acrylic adhesives, one or two-component polychloroprene adhesive, polyvinyl acetate, modified starch, methylcellulose, vinylic dispersion, and mixtures thereof.

29. A product comprising a translucent or transparent paper according to claim 23, wherein the translucent or transparent paper is bonded to a paper, cardboard or paperboard item, with a layer of glue or adhesive disposed between said paper, cardboard or paperboard item and the white ink layer(s) on the reverse side of the fibrous substrate, said glue or adhesive having a thickness in a range from 2 to 12 μm, in particular a glue or adhesive comprising a material selected from the group consisting of polyurethane adhesives, acrylic adhesives, one or two-component polychloroprene adhesive, polyvinyl acetate, modified starch, methylcellulose, vinylic dispersion, and mixtures thereof.

30. A process for producing a product of claim 23 comprising carrying out the steps of the process according to claim 16, further comprising applying a layer of glue on the white ink layer and/or a surface of a paper, cardboard or paperboard item so as to bond the translucent or transparent paper and the paper, cardboard or paperboard item.
